(19) United States
(12) Patent Application Publication
(10) Pub. No.: US 2015/0102159 A1
(43) Pub. Date: Apr. 16, 2015

(54) WATERPROOF MULTI-ROTOR UNMANNED FLYING APPARATUS

(71) Applicant: Russ Hegarty, Livermore, CA (US)

(72) Inventor: Russ Hegarty, Livermore, CA (US)

(21) Appl. No.: 14/513,753

(22) Filed: Oct. 14, 2014

Related U.S. Application Data
(60) Provisional application No. 61/891,076, filed on Oct. 15, 2013.

(51) Int. Cl. B64C 27/08; B64C 27/467; B32B 37/04; B64C 1/06; B64C 1/34; B64C 39/02; B64F 5/00

(52) U.S. Cl. CPC B64C 27/08; B64C 39/024; B64C 27/467; B64F 5/00; B64F 5/0009; B64C 1/061; B64C 1/34; B32B 37/04; B64C 2201/00; B64C 2201/024; B64C 2201/108
USPC 244/17.23; 156/92

(57) ABSTRACT

Disclosed is an invention related to a waterproof unmanned flying apparatus, which is waterproof or water resistant and can perform in inclement weather conditions. The flying apparatus comprises of a main frame covering the outer structure of the flying apparatus that is constructed out of a single piece or multiple pieces which are fused together or mechanically attached to create a watertight seal. A centralized frame can be configured in numerous layouts to include the size and number of rotor blades. The flying apparatus can be used in various applications such as a training device, an aerial photography, and any other event for which the flying apparatus would be required to fly in or around water. The flying apparatus protects expensive internal electrical components that would normally be destroyed by water and moisture. Furthermore, the flying apparatus can be attached with devices for providing features intended for user's consumption.

### CROSS-REFERENCE TO RELATED APPLICATION

This application claims benefit of priority of U.S. Provisional Patent Application Ser. No. 61/891,076, filed Oct. 15, 2013, entitled “Waterproof Multi-rotor Aircraft”, owned by the assignee of the present application and herein incorporated by reference in its entirety.

### BACKGROUND

The present invention relates to a waterproof flying apparatus and more particularly about facilitating a waterproof multi-rotor unmanned flying apparatus that can sustain rugged terrains or any type of environmental conditions.

A conventional unmanned aerial vehicle can be used for various purposes such as a training device, aerial photography, data collection for education and science, disaster relief, search and rescue, and any other event for which the aerial vehicle would be required to fly in or around water. While using the aerial vehicle, expensive internal electrical components are normally destroyed by water and moisture. The existing unmanned aerial vehicle structure is not designed to work in rugged environmental conditions. Further, the aerial vehicle structure is not capable of protecting the expensive electrical components or circuit installed in the vehicle structure as the vehicle structure is collapsible and non-water resistant. During calamities or any other event the aerial vehicle would be required to fly in or around water and in rugged environmental conditions to capture the situation. In such a scenario, the recorded information along with the electrical components installed within the vehicle structure is to be protected. Hence, there is a need for a flying apparatus that can work normally in inclement environmental conditions and must be water and moisture resistant. Further, the flying apparatus must be unbreakable and attributed with light-weight.

### SUMMARY

The present invention is related to facilitating a waterproof multi-rotor unmanned flying apparatus, wherein the flying apparatus comprises of two or more rotors installed in housing and the rotors are associated with a centralized frame of the apparatus. The flying apparatus is covered with a main frame that is made up of a material attributed with unbreakable and light weight properties. A centralized frame is provided at the centre of the apparatus for housing electrical control units and sensors as a single unit and the centralized frame is enclosed using a cover. The cover is sealed to the centralized frame with a means to protect the installed single unit from water and moisture. The rotors are arranged to rotate in substantially parallel axes and each of the rotor is associated with a motor to allow independent control of the rotor. Other objects and advantages of the embodiments herein will become readily apparent from the following detailed description taken in conjunction with the accompanying drawings.

### BRIEF DESCRIPTION OF THE DRAWING(S)

FIG. 1, according to an embodiment of the present invention, illustrates a structure of a conventional multi-rotor flying apparatus.

FIG. 2, according to an embodiment of the present invention, illustrates the structure of the waterproof unmanned multi-rotor flying apparatus.

FIGS. 3a and 3b, according to an embodiment of the present invention, illustrates the motor with threaded inserts and drilled holes.

FIGS. 4a and 4b, according to an embodiment of the present invention, illustrates the motor mounted to the housing.

FIG. 5, according to an embodiment of the present invention, illustrates the side-view of the waterproof unmanned multi-rotor flying apparatus.

FIG. 6, according to an embodiment of the present invention, illustrates the top-view of the waterproof unmanned multi-rotor flying apparatus.

### FIGURES

### Reference Numerals

2—Conventional unmanned multi-rotor flying apparatus

4—A centralized frame associated with one or more rotors

6, 8, 10, 12—Elongated arms protruding outwardly from the centralized frame

14—Vanes provided for stabilizing the apparatus

16—Rotors connected to the centralized frame through the elongated arms

18—Clockwise movement of the rotors

20—Anti-clockwise movement of the rotors

100—Overview of the waterproof unmanned multi-rotor flying apparatus

10—Corrosion resistant screw for the rotor housing

20—Thumb screw fitted on the cover enclosing the centralized frame

30—A foam gasket inserted between the cover enclosing the centralized frame and the centralized frame

40—Cover to enclose the centralized frame

60—Thread inserts for the rotor housing

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

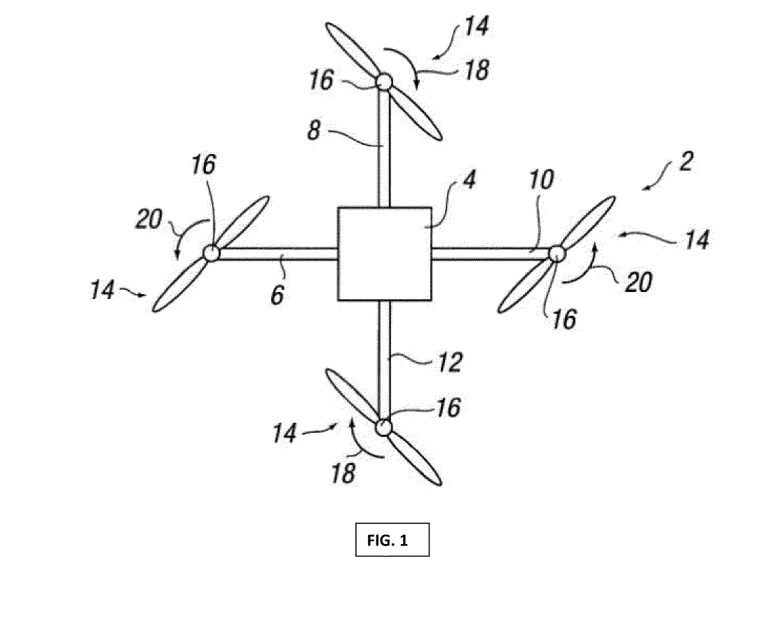

An unmanned flying apparatus can refer to a vehicle, an unmanned aerial vehicle, or an unmanned aircraft system that can be remotely controlled by a person without boarding thereon. Further, the unmanned flying apparatus can include a tri rotor having three propellers, a quad rotor having four propellers, a penta rotor having five propellers, a hexa rotor having six propellers, and an octo rotor having eight propellers, and so on. The quad rotor is used as an example for describing the proposed invention, but the present invention is not limited thereto, and it may be variously modified according to the number and configuration of the propellers. Referring to FIG. 1, illustrates a structure of the conventional multi-rotor flying apparatus.

The unmanned aerial vehicle 2 includes a centralized frame 4 with four elongated arms 6, 8, 10, 12 protruding outwardly to form a substantially cruciform shaped frame when viewed in plan. A rotor 14 is provided at the free end of each arm 6-12 and each rotor 14 is capable of undergoing rotational movement about a substantially vertical axis 16. Oppositely mounted rotors 14 are rotatable in the same direction and adjacently mounted rotors 14 are rotatable in opposite directions. Thus, two rotors move in a clockwise direction 18 and two rotors move in an anti-clockwise direction 20 in use of the aircraft. The torque reactions provided by driving the rotors balance, and the aircraft does not tend to spin about its central axis. Electrical control units along with sensors considered as a single unit is housed in the centralized frame 4 and are typically controlled remotely via a remote control handset. In an embodiment, a motor is associated with each rotor to allow independent control of the same.

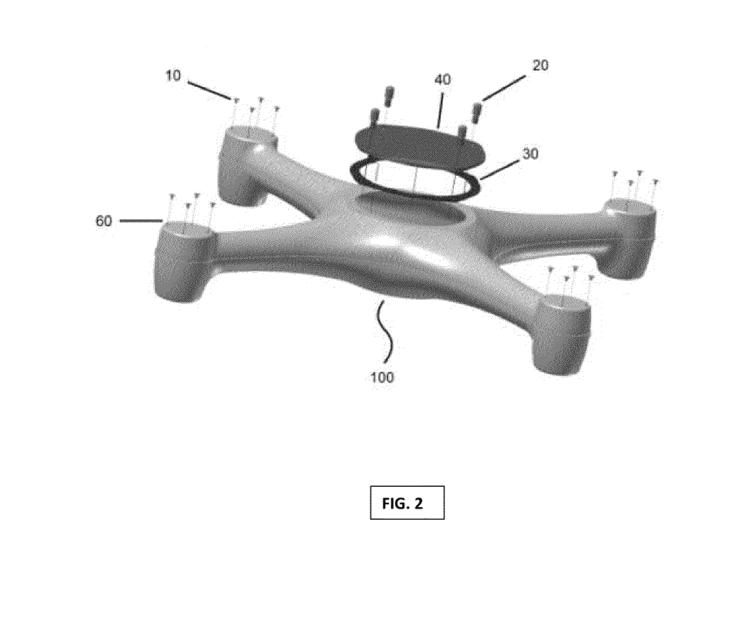

Referring to FIG. 2, illustrates the structure of the waterproof unmanned multi-rotor flying apparatus 100. A structure of a quad rotor with four propellants for an unmanned flying apparatus (quad rotor) is illustrated in the current figure. In an embodiment the centralized frame 4 and the flying apparatus 100 can be supported with various shapes and sizes based on the number of rotors required by the flying apparatus. In an embodiment, the flying apparatus 100 is covered with a main frame structure that is made up of a material which is unbreakable and is light weight. In another embodiment, the main frame structure can be made up a inflatable non-permeable material. Further, the main frame can be designed by using either a single piece structure or by fusing multi-piece structures by chemically melting the seam together and fastening the screws along the seam for designing a single piece structure. For example, the mainframe can be vacuum formed from a Kydex plastic (or similar material) using two halves of the material and then the halves are permanently fused by chemically melting the seam together. As another example, the main frame can be designed using a tough Acrylonitrile butadiene styrene (ABS) 2 piece structures, sized at 585 mm and with symmetrical or asymmetrical halves. The ABS 2 piece structure halves can be binded up with silicone and the binded halves can be fastened with screws so the result is one solid frame structure as depicted in the figure. In another embodiment, the two halves can be screwed together after temporarily fitting the two halves together using an o-ring seal. The main frame structure halves fitted together using the o-ring seal are tightened using fasteners to create a water tight seal that allows the users to easily access all internal components placed within the main frame.

In an embodiment, the rotor housing structure is provided at each end of the main frame along with a centralized frame 100. In an embodiment, each of the rotor housing structure is embodied with any inserts or threaded base material 60 for fastening a screw 10. The screw 10 and threaded base material 60 fastens the brushless motors or motors with propellers of different size and shapes that is mounted at each end of the main frame, depending upon the work to perform and the size of the multi-rotor. In an embodiment, the motors are mounted directly to the rotor housing from outside by fastening the screw in the threaded base material drilled holes.

In an embodiment, the centralized frame 100 has an open space for installation of electronic speed controllers, power distribution board, flight controller, lithium-polymer battery, radio controlled transmitter and receiver (all off the shelf components that make up the invention “Ready to Fly” version installed inside the frame 100) as a single unit. Further, the opening of the centralized frame 100 is then enclosed with a cover 40 that is made up of a material which is unbreakable and is attributed with light weight and the cover 40 can be fitted or fixed to the centralized frame 100. In an embodiment, a means for temporarily or permanently sealing the single unit in the centralized frame 100 is provided between the cover 40 and the centralized frame 100. The single unit placed in the centralized frame 100 is enclosed with the cover 40 that makes the single unit (carried by the flying apparatus) as a waterproof, a water-resistant, or a weather proof. For example, the cover 40 enclosing the centralized frame 100 can be made up of polycarbonate material and the cover 40 and can be fastened to the centralized frame 100 by using a nylon thumbscrew 20 for temporarily enclosing the single unit in the centralized frame 100. In an embodiment, a foam gasket 30 is inserted in between the enclosing cover 40 and the centralized frame 100 to make the enclosed single unit waterproof or water-resistant or weather proof. In another embodiment, the enclosing cover 40 can be latched, interlocked, or sealed to the centralized frame 100 for permanently sealing the single unit placed in the centralized frame 100. In an embodiment, the flying apparatus can be fitted with one or more devices internally or externally and the device provides one or more features for a user's consumption. For example, the flying apparatus can be fitted with a camera, a video recorder, a sound recorder or the like. The camera can capture images or pictures for the user's consumption and the sound recorder device attached to the apparatus can record the audio for the user's consumption. As another example, the flying apparatus can be internally fitted with Light Emitting Diodes (LEDs) that can glow when the battery of the flying apparatus is low or to provide high-visibility of the flying apparatus.

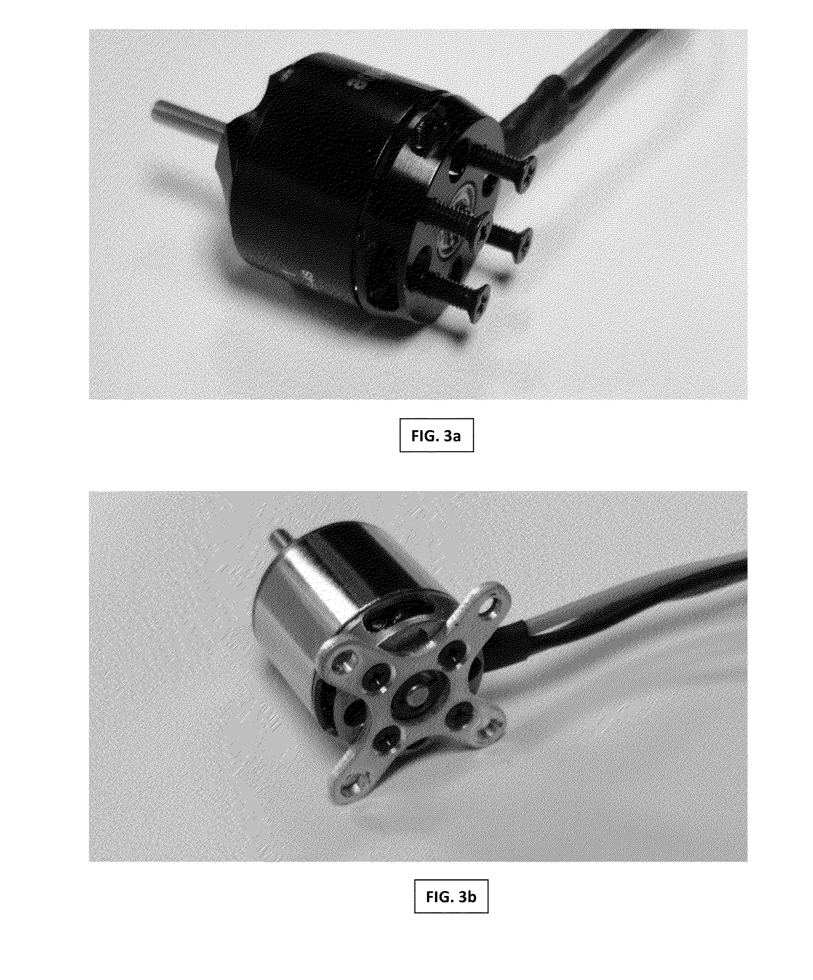

Referring to FIGS. 3a and 3b, illustrates the motor with threaded inserts 60 passed through the drilled holes for mounting the motor to the housing.

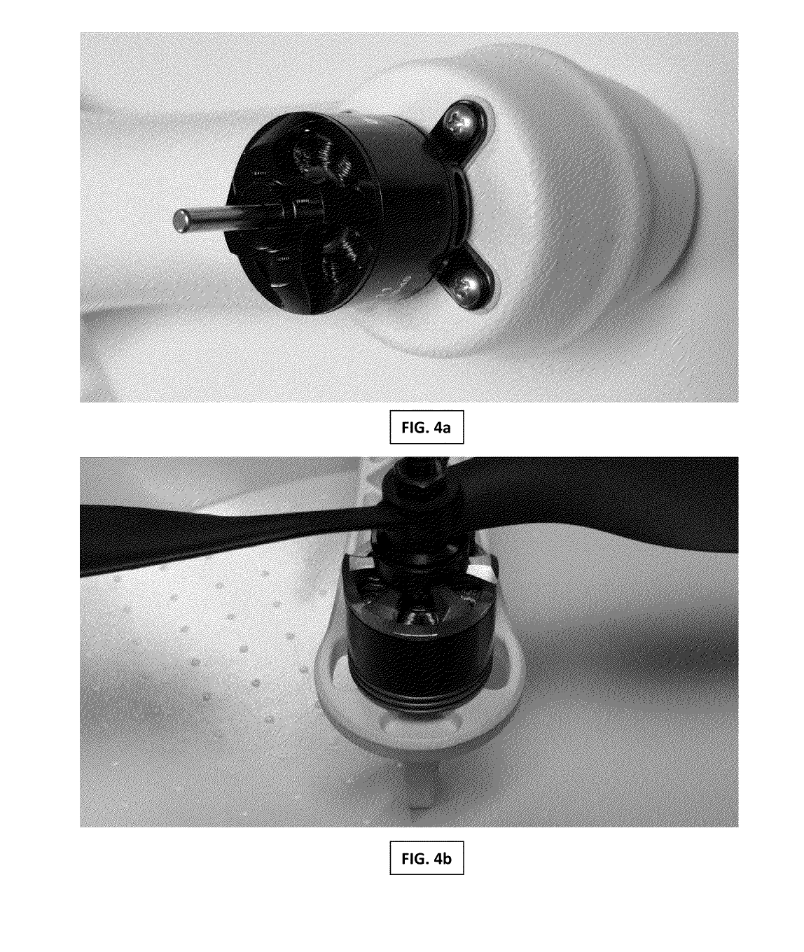

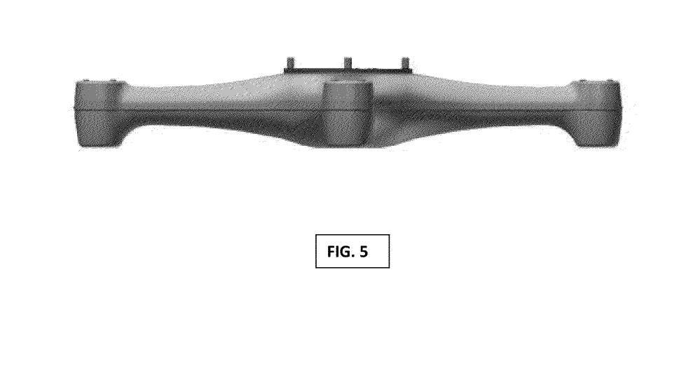

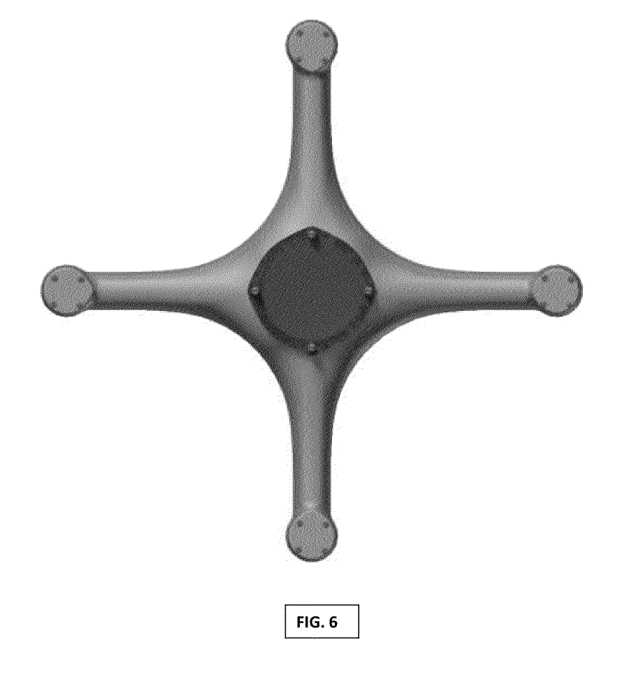

Referring to FIGS. 4a and 4b, illustrates mounting the motor to the housing from outside by fastening the screw on the housing with the threaded inserts 60 passed through the drilled holes. Referring to FIGS. 5 and 6, illustrates the side-view and top-view of the flying apparatus.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims. Although the embodiments herein are described with various specific embodiments, it will be obvious for a person skilled in the art to practice the invention with modifications. However, all such modifications are deemed to be within the scope of the claims.

What is claimed is:

1. A waterproof multi-rotor unmanned flying apparatus comprising:
a) a main frame covering the outer structure of said flying apparatus;
b) a housing with two or more rotor means associated therewith;
c) said rotor means are located or associated with a centralized frame of said aircraft;
d) said rotor means arranged to rotate about substantially parallel axes in use and wherein one or more vanes are provided with said apparatus to help stabilize the apparatus in use; and
e) each said rotor means associated with a motor to allow independent control of said rotor means.

2. The apparatus as claimed in claim 1, wherein said main frame is water-resistant and made up of a material that is unbreakable and light weight.

3. The apparatus as claimed in claim 1, wherein said main frame can be made up of a material that is inflatable and non-permeable.

4. The apparatus as claimed in claim 2, wherein said main frame can be designed by using either a single piece structure or fusing multi-piece structures by chemically melting the seam together and fastening the screws along the seam for designing a single piece structure.

5. The apparatus as claimed in claim 1, wherein said housing is embodied with drilled holes for passing a threaded insert and mounting said rotor means in said housing by fastening the threaded insert with a screw in each of the threaded insert that is resistant to corrosion.

6. The apparatus as claimed in claim 1, wherein said centralized frame is enclosed with a cover for covering the housing of at least one electrical control unit optionally along with a sensor as a single unit in said centralized frame.

7. The apparatus as claimed in claim 6, wherein said cover enclosing said centralized frame is made up of a material that is unbreakable and is attributed with light weight.

8. The apparatus as claimed in claim 6, wherein a means for sealing said single unit is provided between said cover and said centralized frame to make said unit waterproof, water-resistant, or weather proof.

9. The apparatus as claimed in claim 8, wherein said means for sealing said single unit can be one of a temporary sealing, permanent sealing for housing said single unit in said centralized frame.

10. The apparatus as claimed in claim 1, wherein said apparatus can be fitted with at least one device internally or externally to provide at least one feature for a user's consumption.

11. The process of designing a main frame covering the outer structure of a waterproof multi-rotor unmanned flying apparatus comprises of: fusing multi-piece structures by chemically melting the seam together and fastening the seam with screws for designing a single piece structure.
